(19) United States
(12) Patent Application Publication
(10) Pub. No.: US 2016/0085450 A1
(43) Pub. Date: Mar. 24, 2016

(54) SYSTEM FOR PROVIDING REMOTE MEMORY AND TEMPORARY PAGE POOL OPERATING METHOD FOR PROVIDING REMOTE MEMORY

(71) Applicant: Electronics and Telecommunications Research Institute, Daejeon (KR)

(72) Inventors: Shin Young AHN, Daejeon (KR); Young Ho KIM, Daejeon (KR); Eun Ji LIM, Daejeon (KR); Gyu Il CHA, Daejeon (KR)

(21) Appl. No.: 14/673,571

(22) Filed: Mar. 30, 2015

(30) Foreign Application Priority Data
Sep. 18, 2014 (KR) 10-2014-0124501

(51) Int. Cl. G06F 3/06

(52) U.S. Cl. CPC G06F 3/0604; G06F 3/0631; G06F 3/0683

(57) ABSTRACT

The present invention relates to technology for providing a remote memory, and more particularly, to a system for providing a remote memory which may enable an application in a high performance computing system to use a physical memory of a remote computing node like a local memory of a computing node in which the corresponding application is executed, and a temporary page pool operating method for providing a remote memory.

### CROSS-REFERENCE TO RELATED APPLICATION

This application claims priority to and the benefit of Korean Patent Application No. 10-2014-0124501, filed on Sep. 18, 2014, the disclosure of which is incorporated herein by reference in its entirety.

### BACKGROUND

1. Field of the Invention

The present invention relates to technology for providing a remote memory, and more particularly, to a system for providing a remote memory which may enable an application in a high performance computing system to use a physical memory of a remote computing node like a local memory of a computing node in which the corresponding application is executed, and a temporary page pool operating method for providing a remote memory.

2. Discussion of Related Art

A method of using a high performance super node physically having a large capacity memory in order to execute applications that require the large capacity memory requires extremely high costs, and therefore there have been efforts for improving latency and performance of a large capacity memory application using a remote memory.

As examples of a method of improving the latency and performance using the remote memory, a method of using the remote memory as a cache at an application level, a method of using the remote memory as a file system, a method of using the remote memory as both the cache and the file system, and the like are given.

In addition, methods for improving system performance using the remote memory as a network block device, a swap device, and the like have been sought, and as a method of providing memory semantics, there have been efforts for using the remote memory as a distributed shared memory.

Meanwhile, in order for a large capacity memory application to access data stored on the remote memory, it is necessary that a local physical memory page is temporarily allocated, a remote memory page is copied to the temporarily allocated local physical memory page, and then the local physical memory page is mapped on a virtual address space of an application process of the large capacity memory.

When copying the remote memory as a typical communication method, a single communication buffer (memory block) is provided and data of the remote memory is transmitted and received through the communication buffer so that additional memory copy is required, and therefore excellent performance cannot be expected.

According to the development of networking technologies, a delay of copying the remote memory page to a local page tends to be gradually reduced. In particular, when using technologies for supporting remote direct memory access (RDMA) technology such as InfiniBand, Quadrix, or Myrinet, an application level memory page may be copied from a remote system at a time. However, in order to use the RDMA technology, a communication buffer memory should be registered in an RDMA-supporting network interface controller (NIC) in advance and costs for the registration are larger than simple memory copying costs, and therefore, conventionally, a method of separately operating the communication buffer and a temporary memory page has been used. Thus, there is a demand for a method of reducing the number of times of copying between the communication buffer and the temporary memory page.

In a case of access to the remote memory, a page cache mechanism similar to that in a case of access to a disk block is needed. This is because the remote memory has much larger access latency than that of the local memory as described above, and therefore it is required to operate a page cache for the remote memory in order to hide this latency.

However, a remote memory page cache has a different physical memory operating method from a disk page cache. The disk page cache can utilize most of free physical memory as the page cache, and is returned only when a memory shortage occurs.

On the other hand, the application of using the remote memory uses the remote memory due to the shortage of the local memory, and therefore the use of a local physical memory that is used as a temporary local page in order to use a large capacity remote memory should be minimized

Therefore, it is necessary to provide page cache services for the remote memory by utilizing a temporary page pool (collection) with a limited size. In addition, the temporary page pool should act as a communication buffer in order to reduce the number of times of copying between the communication buffer and the temporary memory page as described above. In order to support that the large capacity remote memory is used like the local memory by utilizing the limited temporary page pool, there is a need for a method of effectively operating the temporary page pool.

### SUMMARY OF THE INVENTION

The present invention is directed to a system for providing a remote memory which may enable an application in a high performance computing system to use a physical memory of a remote computing node like a local memory of a computing node in which the corresponding application is executed, and an effective temporary page pool operating method for providing a remote memory.

According to an aspect of the present invention, there is provided a system for providing a remote memory including: a grant memory agent unit that is executed in a memory grant node to register a grant memory; a remote memory integrated management unit that is executed in a management node to manage a pool for the grant memory registered by the grant memory agent unit, and finds an appropriate unallocated memory block from a grant memory pool to allocate the found memory block when there is a request for use of the remote memory from the outside; and a remote memory use support unit that is executed in a memory user node, supports that a remote memory user uses an allocated remote memory by requesting allocation of the remote memory from the remote memory integrated management unit according to a request of the remote memory user, and maps the allocated remote memory on a virtual address space of the remote memory user so that the remote memory user uses the remote memory.

Here, when a page fault occurs as the virtual address space of the remote memory is accessed by the remote memory user, the remote memory use support unit may allocate an unused temporary page from a temporary page pool on a local physical memory of the memory user node, copy contents of a remote memory page of the memory grant node to the allocated temporary page, and map the temporary page to which the contents of the remote memory page are copied, on the virtual address space of the remote memory user.

Also, the temporary page pool may include an unused page list that is constituted of unused temporary pages to be used as a remote memory page cache, an active page list that is constituted of temporary pages which are temporarily used in order for the remote memory user to access the remote memory, an modified page list that is constituted of pages which are required to be stored into the remote memory because the remote memory user has performed data writing in the temporary page among the temporary pages which are not used by the remote memory user for a predetermined time to be inactivated, and an inactive page list that is constituted of temporary pages which are returned to the unused page list because the remote memory user has not performed data writing into the temporary pages which are not used by the remote memory user for a predetermined time to be inactivated.

According to another aspect of the present invention, there is provided a method for operating a temporary page pool for providing a remote memory, including: allocating a temporary page; and returning the temporary page, wherein the allocating of the temporary page includes determining whether pre-reading is set when receiving a request for access to a specific page of the remote memory from a remote memory user, performing a pre-reading processing flow operation when the pre-reading is determined to be set, and determining whether a previously allocated temporary page exists when the pre-reading is determined not to be set, and allocating an unallocated temporary page from the temporary page pool when the previously allocated temporary page is determined not to exist, determining whether the previously allocated temporary page exists in an active page list when the previously allocated temporary page is determined to exist, and performing active page reordering or reactivating an inactive page.

Also, the allocating of the unallocated temporary page of the temporary page pool may include newly allocating an unused temporary page in an unused page list, and reading data of the remote memory in the newly allocated temporary page when a remote memory page is effective and then moving the newly allocated temporary page to an end of the active page list.

Also, the performing of the active page reordering or the reactivating of the inactive page may include performing the active page reordering when the previously allocated temporary page exists in the active page list.

Also, the performing of the active page reordering or the reactivating of the inactive page may include reactivating the inactive page when the previously allocated temporary page does not exist in the active page list.

Also, in the performing of the active page reordering or the reactivating of the inactive page, the active page reordering may be performed by moving an order of the previously allocated temporary page to the end of the active page list.

Also, in the performing of the active page reordering or the reactivating of the inactive page, the reactivating of the inactive page may be performed by moving the inactive page from a modified page list or the inactive page list to the end of the active page list.

Also, the returning of the temporary page may include determining whether a temporary page exceeding a predetermined ratio exists in the active list, and inactivating the temporary pages exceeding the predetermined ratio when the temporary page exceeding the predetermined ratio is determined to exist.

Also, the inactivating of the temporary page exceeding the predetermined ratio may include determining whether the temporary page is required to be stored in the remote memory, storing the temporary page into the remote memory when the temporary page is required to be stored into the remote memory, and returning the temporary page when the temporary page is not required to be stored into the remote memory.

Also, the determining of whether the temporary page exceeding the predetermined ratio exists in the active list is performed in a period which is inversely proportional to a speed in which the active page list is filled.

Also, the inactivating of the temporary page exceeding the predetermined ratio may include inactivating the temporary page starting from the temporary page positioned at the head of the active page list by the number of the temporary pages exceeding the predetermined ratio.

Also, the returning of the temporary page when the temporary page is not required to be stored in the remote memory may be performed by moving the temporary pages existing in the inactive page list to an unused page list.

Also, the performing of the pre-reading processing flow operation may include determining whether access to the remote memory is sequentially performed, determining whether a pre-reading flag is set when the access to the remote memory is determined to be sequentially performed, setting the pre-reading flag when the pre-reading flag is determined not to be set, and initializing a current window and a pre-reading window, and determining whether a requested remote page exists in the pre-reading window when the pre-reading flag is determined to be set, and correcting the current window and the pre-reading window when the requested remote page is determined to exist in the pre-reading window.

Also, the performing of the pre-reading processing flow operation may further include determining whether the pre-reading flag is set when the access to the remote memory is determined not to be sequentially performed, and resetting the current window and the pre-reading window when the pre-reading flag is determined to be set.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a configuration diagram of a high performance computing system in which a system for providing a remote memory according to an embodiment of the present invention is implemented;

FIG. 2 is a configuration diagram of a system for providing a remote memory according to an embodiment of the present invention;

FIG. 3 is an exemplary diagram illustrating a remote memory access method in a system for providing a remote memory according to an embodiment of the present invention;

FIG. 4 is a structural diagram of a temporary page pool used in providing a remote memory using a system for providing a remote memory according to an embodiment of the present invention;

FIG. 5 is a flowchart illustrating a temporary page allocation method when processing a page fault that occurs at the time of access to a remote memory using a system for providing a remote memory according to an embodiment of the present invention;

FIG. 6 is a flowchart illustrating a temporary page returning method of the temporary page pool shown in FIG. 4; and

FIG. 7 is a flowchart illustrating a detailed procedure for a pre-reading processing operation of FIG. 5.

FIG. 8 is a block diagram illustrating a computer system to which the present invention is applied.

### DETAILED DESCRIPTION OF EXEMPLARY EMBODIMENTS

Example embodiments of the present invention are disclosed herein. Also, specific structural and functional details disclosed herein are merely representative for purposes of describing the example embodiments of the present invention. However, the example embodiments of the present invention may be embodied in many alternative forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

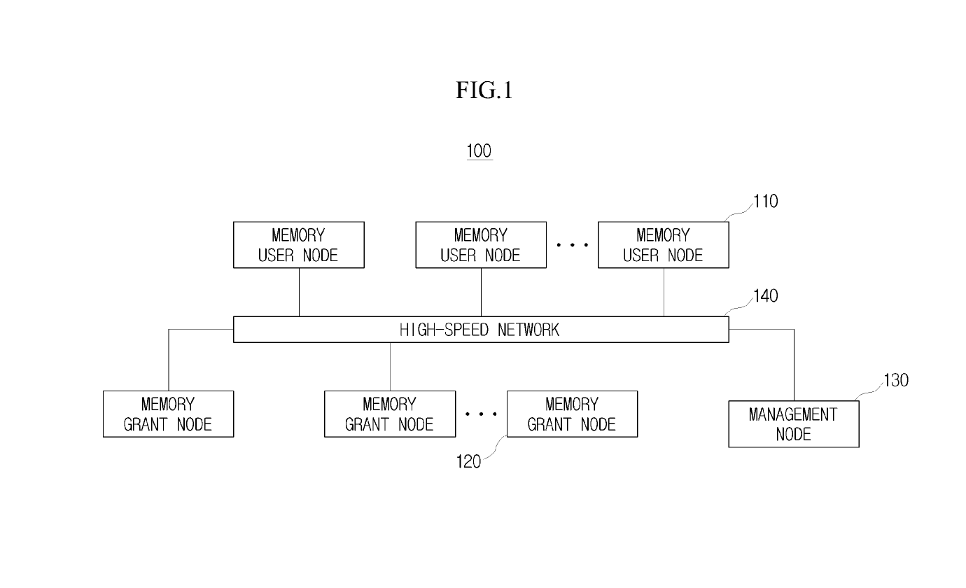

FIG. 1 is a configuration diagram of a high performance computing system in which a system for providing a remote memory according to an embodiment of the present invention is implemented, and illustrates an example of a high performance computing system capable of accessing a remote memory.

Referring to FIG. 1, the high performance computing system 100 may include a memory user node 110, a memory grant node 120, and a management node 130, and a plurality of memory user nodes 110 and a plurality of memory grant nodes 120 may be provided in the high performance computing system.

Meanwhile, the memory user node 110, the memory grant node 120, and the management node 130 may be implemented so as to perform communication in such a manner as to be connected to each other through a high-speed network 140, but connection for communication is not performed only by a kind of high-speed network.

In addition, an application using a remote memory is executed in the memory user node 110, and the memory grant node 120 provides its own memory to a remote memory user application.

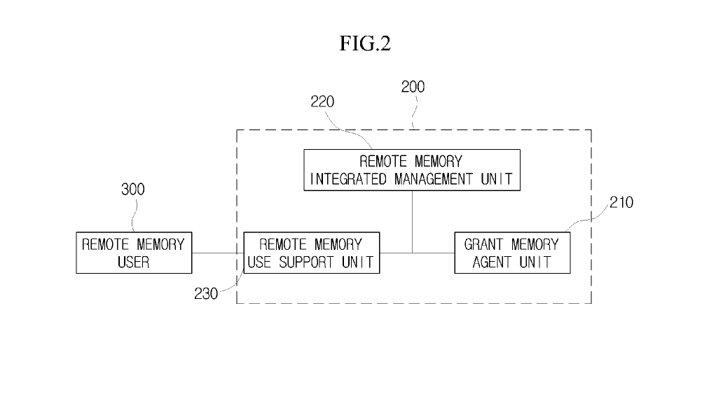

FIG. 2 is a configuration diagram of a system for providing a remote memory according to an embodiment of the present invention. Referring to FIG. 2, the system 200 for providing the remote memory according to an embodiment of the present invention includes a grant memory agent unit 210, a remote memory integrated management unit 220, and a remote memory use support unit 230.

The grant memory agent unit 210 acts as an application which is executed in the memory grant node 120 of FIG. 1, and registers a grant memory into the remote memory integrated management unit 220.

The remote memory integrated management unit 220 acts as an application which is executed in the management node 130 of FIG. 1, manages a pool for the grant memory registered in the grant memory agent unit 210, and finds an appropriate unallocated memory block from a grant memory pool to allocate the found memory block to the remote memory use support unit 230 when there is a request for use of the remote memory from the remote memory use support unit 230.

The remote memory use support unit 230 acts as an application which is executed in the memory user node 110 of FIG. 1, and supports that a remote memory user 300 uses the remote memory by requesting allocation of the remote memory from the remote memory integrated management unit 220 according to a request of the remote memory user 300 that is an application of actually using the remote memory.

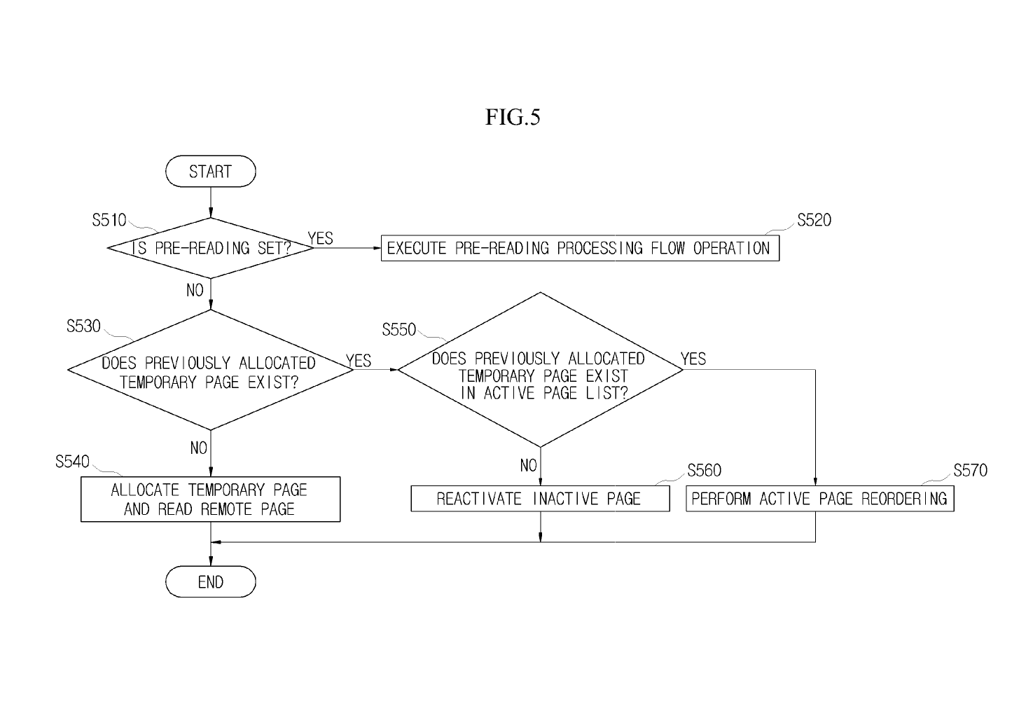

In this instance, the remote memory user 300 is executed in the memory user node 110 of FIG. 1, and specific function of the remote memory use support unit 230 will be understood through FIGS. 5 to 7.

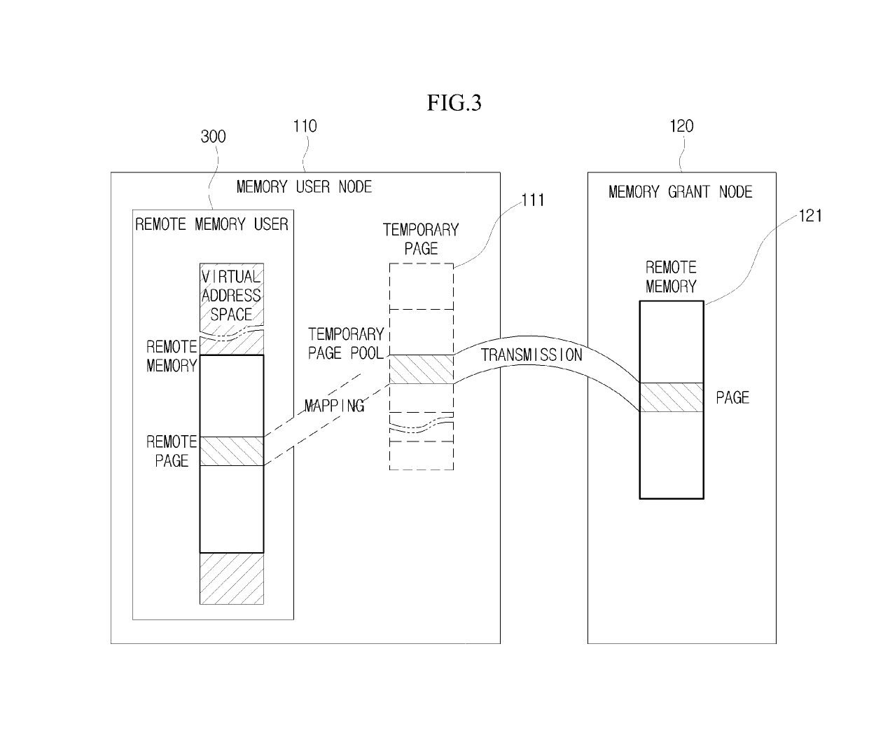

FIG. 3 is an exemplary diagram illustrating a remote memory access method in a system for providing a remote memory according to an embodiment of the present invention.

Referring to FIG. 3, the remote memory user 300 is executed in the memory user node 110. In addition, although not shown in FIG. 3, the remote memory use support unit 230 of FIG. 2 which supports that the remote memory user 300 can use the remote memory is executed in the memory user node 110.

In this instance, FIG. 3 is an example in which the remote memory is provided like a local memory, and the remote memory use support unit 230 of FIG. 2 allows a memory page of the memory user node 110 to be temporarily mapped on a virtual address space of the remote memory user 300 to access. The memory page is a temporarily used memory, and in the present invention, is referred to as “temporary page”.

A remote memory 121 may be allocated from the system 200 for providing the remote memory as shown in FIG. 2 to the remote memory user 300. In this instance, the remote memory 121 is a grant memory registered by the grant memory agent unit 210 executed in the memory grant node 120, and allocation of the remote memory is performed by the remote memory use support unit 230 of FIG. 2.

When the remote memory user 300 accesses a specific page of the remote memory 121 which is previously allocated, data of the corresponding page of the remote memory 121 does not exist in the memory user node 110, and therefore a page fault may occur.

In this manner, when the page fault occurs, the remote memory use support unit 230 of the system 200 for providing the remote memory allocates a single unused temporary page from a temporary page pool 111 on a local physical memory of the memory user node 110.

The remote memory use support unit 230 copies contents of a remote memory page of the memory grant node 120 to the allocated temporary page, and maps the temporary page to which the contents of the remote memory page are copied on a virtual address space of the remote memory user 300.

Meanwhile, in FIG. 3, an example in which the remote memory is mapped on the virtual address space to be provided is shown, but the present invention may be achieved by a method of accessing the remote memory through a dedicated application programming interface (API) without mapping the temporary page on the virtual address space of the remote memory user 300.

As described with reference to FIG. 3, in order to temporarily store the remote memory, the temporary page which is not used in the temporary page pool 111 is allocated, and the allocated temporary page is used as a remote memory page cache and then returned.

In this instance, according to an embodiment of the present invention, in order to operate the temporary page as the remote memory page cache, the temporary page pool 111 is internally divided into four lists to be operated.

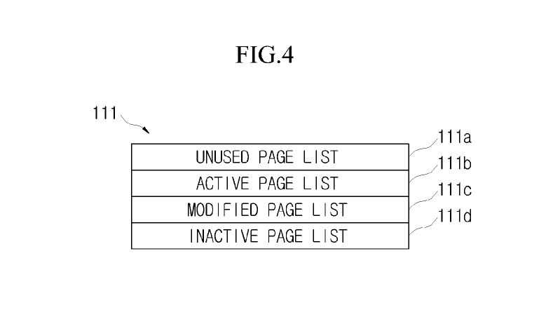

Hereinafter, a structure of a temporary page pool will be described with reference to FIG. 4.

FIG. 4 is a structural diagram of a temporary page pool used in providing a remote memory using a system for providing a remote memory according to an embodiment of the present invention.

Referring to FIG. 4, the temporary page pool 111 used in providing the remote memory using the system for providing the remote memory according to an embodiment of the present invention may be divided into an unused page list 111a, an active page list 111b, a modified page list 111c, and an inactive page list 111d.

The unused page list 111a is constituted of unused temporary pages to be used as the remote memory page cache. That is, the unused temporary pages may be managed within the unused page list 111a.

The active page list 111b is constituted of temporary pages which are temporarily used in order for the remote memory user 300 to access the remote memory, and the temporary pages which are temporarily used are managed within the active page list 111b.

The modified page list 111c is constituted of pages which are required to be stored into the remote memory because the remote memory user 300 has performed data writing in the temporary page among the temporary pages which are not used by the remote memory user 300 for a predetermined time to be inactivated, and the pages required to be stored in the remote memory are managed within the modified page list 111c.

The inactive page list 111d is constituted of pages which will be returned to the unused page list 111a because the remote memory user 300 has not performed data writing into the temporary pages which are not used by the remote memory user 300 for a predetermined time to be inactivated, and the pages which can be immediately returned to the unused page list 111a are managed within the inactive page list 111d.

Hereinafter, a method for operating a temporary page pool for providing a remote memory according to an embodiment of the present invention and a method for processing a page fault will be described in detail with reference to the accompanying drawing.

FIG. 5 a flowchart illustrating a temporary page allocation method when processing a page fault that occurs at the time of access to a remote memory using a system for providing a remote memory according to an embodiment of the present invention.

Referring to FIG. 5, in operation S510, whether pre-reading is set is determined

In operation S520, when the pre-reading is determined to be set, a pre-reading processing flow operation is performed.

In operation S530, when the pre-reading is determined not to be set in operation S510, whether a previously allocated temporary page exists is determined

In operation S540, when the previously allocated temporary page is determined not to exist, a temporary page is allocated and a remote page is read. In this instance, an unallocated page of the temporary page pool 111 is allocated as the temporary page. In this instance, when the previously allocated temporary page is determined not to exist, the remote memory use support unit 230 newly allocates an unused temporary page in the unused page list 111a, and when the remote memory page becomes effective, the remote memory use support unit 230 reads data of the remote memory to the newly allocated temporary page, and then moves an order of the newly allocated temporary page to the end of the active page list 111b so that the remote memory user can access the newly allocated temporary page. Here, the remote memory page may or may not have effective data.

Meanwhile, when the remote memory is not utilized for the purpose of sharing in operation S540, effectiveness of the remote memory page is determined, and when the remote memory page is determined not to be effective, an operation of reading the remote page may be omitted.

However, in operation S550, when the previously allocated temporary page is determined to exist in operation S530, whether the previously allocated temporary page exists in the active page list 111b is determined.

In operation S560, when the previously allocated temporary page is determined not to exist in the active page list 111b, it is determined that the previously allocated temporary page exists in the modified page list 111c or the inactive page list 111d to thereby reactivate the inactive page.

However, when the previously allocated temporary page is determined to exist in the active page list 111b in operation S550, this may correspond to a case in which a page cache hit is performed, and therefore reordering of moving an order of the previously allocated temporary page to the end of the active page list 111b is performed in operation S570.

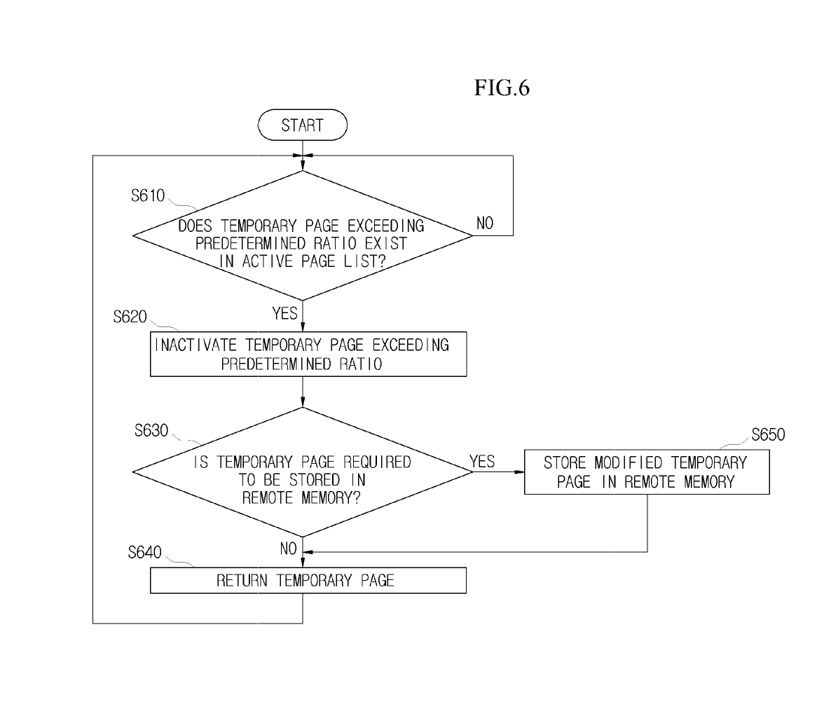

FIG. 6 is a flowchart illustrating a temporary page returning method of the temporary page pool shown in FIG. 4.

Referring to FIG. 6, in operation S610, a temporary page is first allocated, and then whether a temporary page exceeding a predetermined ratio exists among the allocated temporary pages is determined

In operation S620, when the temporary page exceeding the predetermined ratio is determined to exist, inactivation is performed on the temporary page exceeding the predetermined ratio. In this instance, when inactivation is performed on the temporary page, inactivation is performed by the number of the temporary pages exceeding the predetermined ratio, and inactivation is performed on the temporary pages starting from the oldest temporary page positioned at the head of the active page list 111b. Here, the inactivation waits for storage of the remote memory and returning of the temporary page by moving corresponding data to the inactive list, and this does not mean that the remote memory user cannot access the corresponding temporary page. When the remote memory user changes data of the temporary page, the data is moved to the modified page list 111c, and when the remote memory user does not change the data of the temporary page, the data is moved to the inactive page list 111d.

In operation S630, when activation is performed on the temporary page exceeding the predetermined ratio in operation S620, whether the temporary page is required to be stored in the remote memory is determined

When the temporary page is determined to be required to be stored in the remote memory in operation S630, the corrected temporary page is stored in the remote memory in operation 650, and when the temporary page is determined not to be required to be stored in the remote memory in operation S630, the temporary page is returned in operation S640.

In this instance, in operation S650 in which the modified temporary page is stored in the remote memory, the temporary page of the modified page list is periodically copied to the remote memory. The temporary page that has been copied to the remote memory can be returned, and thus is moved to the inactive page list.

In addition, operation S640 of returning the temporary page is performed by moving the temporary pages existing in the inactive page list to the unused page list, and the remote memory user cannot use the corresponding temporary page from the moment that the temporary page is deleted from the inactive page list.

Meanwhile, operation S610 of determining whether the temporary page exceeding the predetermined ratio exists among the allocated temporary pages is periodically performed, and is performed in a period which is inversely proportional to a speed in which the active page list is filled. As a speed in which a new temporary page is filled in the active page list is faster, the period is reduced, and as the speed in which the new temporary page is filled in the active page list is slower, the period is increased. In this manner, changing of the period is to solve a temporary page shortage problem that may occur when inactivation is performed in a fixed period.

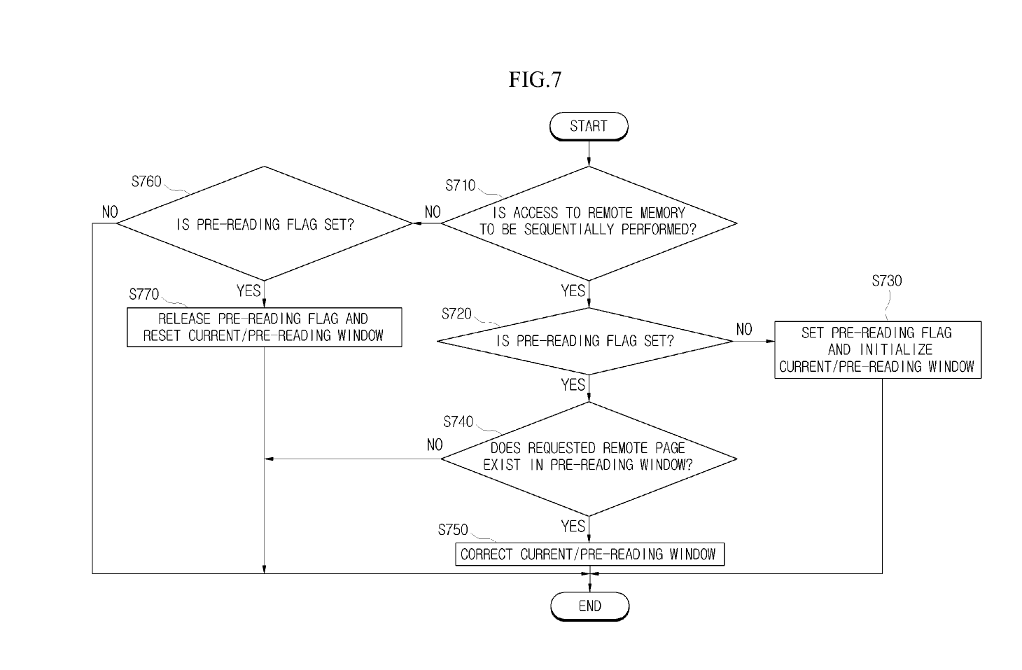

FIG. 7 is a flowchart illustrating a detailed procedure for operation S520 of FIG. 5, that is, a pre-reading processing flow operation.

In operation S520 of processing the pre-reading processing flow operation of FIG. 5, the pre-reading processing flow operation includes setting a pre-reading flag, setting a current window, and setting a pre-reading window. In this instance, the pre-reading flag indicates that the remote memory use support unit performs pre-reading, the current window indicates a region of the remote page that has been already read, and the pre-reading window indicates a region of the remote page in which the remote memory use support unit should perform reading to a previously.

Referring to FIG. 7, whether access to the remote memory is sequentially performed is determined in operation S710, and when the access to the remote memory is determined to be sequentially performed, whether the pre-reading flag is set is determined in operation S720. In this instance, when the remote page that accesses the previous page fault is the same as the previous page of the page desired to be currently accessed, or when the remote page that accesses the previous page fault is the first page of the current window and the page desired to be currently accessed is the first page of the pre-reading window, it is determined that the access to the remote memory is sequentially performed.

Meanwhile, when the pre-reading flag is determined not to be set in operation S720, it is first determined that the access to the remote memory is continuously performed, and therefore the pre-reading flag is set and the current window and the pre-reading window are initialized in operation S730.

However, when the pre-reading flag is determined to be set in operation S720, it is determined that a pre-reading processing operation is already performed, and therefore whether the requested remote page exists in the pre-reading window is determined in operation S740.

Next, when the requested remote page is determined to exist in the pre-reading window in operation S740, the current window and the pre-reading window are corrected in operation S750.

However, when the requested remote page is determined not to exist in the pre-reading window in operation S740, the pre-reading processing operation is completed.

Meanwhile, when the access to the remote memory is determined not to be sequentially performed in operation S710, whether the pre-reading flag is set is determined in operation S760.

In this instance, when the pre-reading flag is determined to be set in operation S760, the pre-reading flag is reset and the current window and the pre-reading window are reset in operation S770, and when the pre-reading flag is determined not to be set in operation S760, the pre-reading processing operation is completed.

As described above, when the pre-reading flag is set, the remote memory use support unit immediately allocates temporary pages for pages on the remote memory corresponding to the pre-reading window, and reads the pages on the remote memory to each of the temporary pages.

As described above, according to the embodiments of the present invention, in the high performance computing system, an application may use a physical memory of a remote computing node like a local memory of a computing node in which the corresponding application is executed.

In addition, a temporary page pool which is used to enable the remote physical memory to be used like the local memory may be configured, and therefore the temporary pages may be allocated when the application dynamically accesses a page of the remote memory at a high speed, and automatically returned when a predetermined time elapses so that the temporary page pool may be reutilized.

In addition, a page cache service for access to the remote memory may be provided to the application, and when the application sequentially access the remote memory, access latency to the remote memory may be minimized through pre-reading, and utilization of a network bandwidth may be maximized.

In addition, by variably adjusting a returning period of the allocated temporary page, when a page fault occurs, the page cache may be maintained for a time as long as possible while satisfying a condition in which the temporary page can be immediately allocated, thereby increasing a cache hit rate.

An embodiment of the present invention may be implemented in a computer system, e.g., as a computer readable medium.

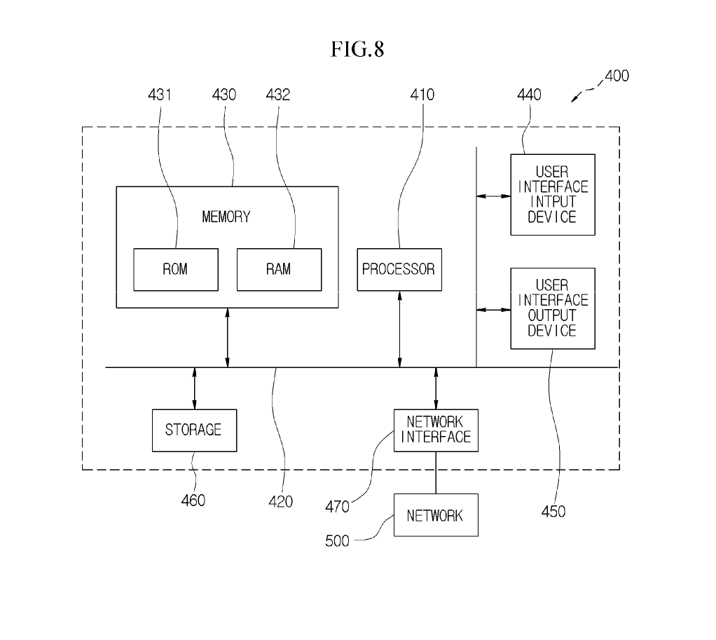

FIG. 8 is a block diagram illustrating a computer system to which the present invention is applied.

As shown in FIG. 8, a computer system 400 may include one or more of a processor 410, a memory 430, a user input device 440, a user output device 450, and a storage 460, each of which communicates through a bus 420. The computer system 400 may also include a network interface 470 that is coupled to a network 500. The processor 410 may be a central processing unit (CPU) or a semiconductor device that executes processing instruction stored in the memory 430 and/or the storage 460. The memory 430 and the storage 460 may include various forms of volatile or non-volatile storage media. For example, the memory 430 may include a read-only memory (ROM) 431 and a random access memory (RAM) 432.

Accordingly, an embodiment of the invention may be implemented as a computer implemented method or as a non-transitory computer readable medium with computer executable instruction stored thereon. In an embodiment, when executed by the processor, the computer readable instruction may perform a method according to at least one aspect of the invention.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system for providing a remote memory comprising:
a grant memory agent unit that is executed in a memory grant node to register a grant memory;
a remote memory integrated management unit that is executed in a management node to manage a pool for the grant memory registered by the grant memory agent unit, and finds an appropriate unallocated memory block from a grant memory pool to allocate the found memory block when there is a request for use of the remote memory from the outside; and
a remote memory use support unit that is executed in a memory user node, supports that a remote memory user uses an allocated remote memory by requesting allocation of the remote memory from the remote memory integrated management unit according to a request of the remote memory user, and maps the allocated remote memory on a virtual address space of the remote memory user so that the remote memory user uses the remote memory.

2. The system of claim 1, wherein, when a page fault occurs as the virtual address space of the remote memory is accessed by the remote memory user, the remote memory use support unit allocates an unused temporary page from a temporary page pool on a local physical memory of the memory user node, copies contents of a remote memory page of the memory grant node to the allocated temporary page, and maps the temporary page to which the contents of the remote memory page are copied, on the virtual address space of the remote memory user.

3. The system of claim 2, wherein the temporary page pool includes
an unused page list that is constituted of unused temporary pages to be used as a remote memory page cache,
an active page list that is constituted of temporary pages which are temporarily used in order for the remote memory user to access the remote memory,
an modified page list that is constituted of temporary pages which are required to be stored into the remote memory because the remote memory user has performed data writing in the temporary page among the temporary pages which are not used by the remote memory user for a predetermined time to be inactivated, and
an inactive page list that is constituted of temporary pages which are returned to the unused page list because the remote memory user has not performed data writing into the temporary pages which are not used by the remote memory user for a predetermined time to be inactivated.

4. A method for operating a temporary page pool for providing a remote memory, comprising:
allocating a temporary page; and
returning the temporary page,
wherein the allocating of the temporary page includes
determining whether pre-reading is set when receiving a request for access to a specific page of the remote memory from a remote memory user,
performing a pre-reading processing flow operation when the pre-reading is determined to be set, and determining whether a previously allocated temporary page exists when the pre-reading is determined not to be set, and
allocating an unallocated temporary page from the temporary page pool when the previously allocated temporary page is determined not to exist, determining whether the previously allocated temporary page exists in an active page list when the previously allocated temporary page is determined to exist, and performing active page reordering or reactivating an inactive page.

5. The method of claim 4, wherein the allocating of the unallocated temporary page of the temporary page pool includes newly allocating an unused temporary page in an unused page list, and reading data of the remote memory in the newly allocated temporary page when a remote memory page is effective and then moving the newly allocated temporary page to an end of the active page list.

6. The method of claim 4, wherein the performing of the active page reordering or the reactivating of the inactive page includes performing the active page reordering when the previously allocated temporary page exit in the active page list.

7. The method of claim 4, wherein the performing of the active page reordering or the reactivating of the inactive page includes reactivating the inactive page when the previously allocated temporary page does not exist in the active page list.

8. The method of claim 4, wherein, in the performing of the active page reordering or the reactivating of the inactive page, the active page reordering is performed by moving an order of the previously allocated temporary page to the end of the active page list.

9. The method of claim 4, wherein, in the performing of the active page reordering or the reactivating of the inactive page, the reactivating of the inactive page is performed by moving the inactive page from a modified page list or the inactive page list to the end of the active page list.

10. The method of claim 4, wherein the returning of the temporary page includes
determining whether a temporary pages exceeding a predetermined ratio exist in the active list, and
inactivating the temporary pages exceeding the predetermined ratio when the temporary pages exceeding the predetermined ratio is determined to exist.

11. The method of claim 10, wherein the inactivating of the temporary page exceeding the predetermined ratio includes determining whether the temporary page is required to be stored in the remote memory, storing the temporary page into the remote memory when the temporary page is required to be stored into the remote memory, and returning the temporary page when the temporary page is not required to be stored into the remote memory.

12. The method of claim 10, wherein the determining of whether the temporary page exceeding the predetermined ratio exists in the active list may be is performed in a period which is inversely proportional to a speed in which the active page list is filled.

13. The method of claim 10, wherein the inactivating of the temporary page exceeding the predetermined ratio includes inactivating the temporary page starting from the temporary page positioned at the head of the active page list by the number of the temporary pages exceeding the predetermined ratio.

14. The method of claim 11, wherein the returning of the temporary page when the temporary page is not required to be stored in the remote memory is performed by moving the temporary pages existing in the inactive page list to an unused page list.

15. The method of claim 4, wherein the performing of the pre-reading processing flow operation includes
determining whether access to the remote memory is sequentially performed,
determining whether a pre-reading flag is set when the access to the remote memory is determined to be sequentially performed,
setting the pre-reading flag when the pre-reading flag is determined not to be set, and initializing a current window and a pre-reading window, and
determining whether a requested remote page exists in the pre-reading window when the pre-reading flag is determined to be set, and correcting the current window and the pre-reading window when the requested remote page is determined to exist in the pre-reading window.

16. The method of claim 15, wherein the performing of the pre-reading processing flow operation further includes
determining whether the pre-reading flag is set when the access to the remote memory is determined not to be sequentially performed, and
resetting the current window and the pre-reading window when the pre-reading flag is determined to be set.
